(19) United States
(12) Patent Application Publication
(10) Pub. No.: US 2019/0059542 A1
(43) Pub. Date: Feb. 28, 2019

(54) SYSTEM AND METHOD FOR PROTECTING FRAGILE OBJECTS

(71) Applicant: INDIAN INSTITUTE OF TECHNOLOGY, DELHI, New Delhi (IN)

(72) Inventors: Sudipto MUKHERJEE, New Delhi (IN); Varan GUPTA, New Delhi (IN); Rishabh BAID, New Delhi (IN)

(21) Appl. No.: 16/070,981

(22) PCT Filed: Jan. 17, 2017
(86) PCT No.: PCT/IB2017/050239

§ 371 Date: Jul. 18, 2018

(30) Foreign Application Priority Data
Jan. 18, 2016 (IN) 201611001797

(51) Int. Cl. A45C 11/00

(52) U.S. Cl. CPC A45C 11/00; H04B 1/3888; A45C 2011/003; A45C 2011/002

(57) ABSTRACT

The present invention provides a system and device for protecting of fragile or delicate objects from impact forces during a fall, wherein said system comprising: at least one detection system for continuously monitoring a state of said objects and configured to detect an event of fall of said objects; at least one actuation mechanism responsive to said event of fall of said objects detected by said detection system; at least one energy transfer mechanism triggered by said actuation mechanism, wherein said energy transfer mechanism adapted to be configured in a strained configuration and to subsequently trigger to expand to a free state configuration when an event of fall is detected; wherein, said energy transfer mechanism adapted to first receive said impact force such that said energy transfer mechanism makes a contact with an impact surface before said object, and thereby said energy transfer mechanism adapted to enable partial buffering of kinetic energy on collision of said object with said impact surface, thereby protecting said objects falling with any orientation from said impact force.

### TECHNICAL FIELD OF THE INVENTION

The present subject matter described herein, in general, relates to protecting fragile or delicate objects which are susceptible to breakage and more particularly, to a system, device and method for protecting fragile or delicate objects from impact during fall.

### BACKGROUND OF THE INVENTION

Small lightweight objects especially electronic devices like mobile phones are damaged due to accidental drops or falls. When a breakable device sustains a hard impact, or high acceleration force loads, the impact forces on the device can be many times the actual weight of the device. The sudden change in kinetic energy stored in the device must be absorbed on impact. If the device's outer case has very little resilience then all the kinetic energy must be absorbed in a very short distance. This results in large peak accelerations and large peak forces exerted on the device, which increases the chances that the device and/or its internal systems will be damaged.

Even though these devices are encased with protective cases, selective elements may be damaged on impact with a surface after freefall. A number of cases are presently available in the market, which use multiple layers of impact absorbing materials like TPU, Silicone etc. all over, which adds substantially to the bulk of the case. Further, the cases also use padded corners on the device, but this adds significant volume and weight to the device, making it more bulky, which is a big disadvantage for modern electronic systems like laptop computers, PDAs, cellular phones, etc., where the smaller and lighter devices sell the best.

Further, Apple Inc. has a solution (no known prototype in market) using reorientation of the phone in mid-flight to protect the most sensitive components of phone (for ex. Screen). Although it may save screen and other sensitive components but it does not decrease the impact force thereby damaging the other parts of the phone.

Reference is made to U.S. Pat. No. 8,903,519 B2, wherein an electronic device including a processor, a sensor in communication with the processor and a protective mechanism. The protective mechanism is in communication with the processor and is configured to selectively alter a center of mass of the electronic device. Additionally, the electronic device also includes an enclosure configured to at least partially enclose the processor and the sensor.

Reference is made to US 20110194230 A1, wherein a system and method for protecting devices from impact damage is provided. Prior to impact between a surface and a device, a determination of a risk of damage to the device is made. If the risk of damage to the device exceeds a threshold, a protection system is activated to reduce or substantially eliminate damage to the device.

Reference is made to U.S. Pat. No. 7,059,182 B1, wherein an impact protection system for a portable device, comprising a housing 20 with a plurality of impact absorbing arms 22 attached to housing 20 and having a retracted position and an extended position; an extension spring 26 connected to each arm provides forceful extension of the arms from their retracted position to their extended position; a free-fall detection sensor 30 defined within housing 20 for detecting dangerous free-fall conditions of the portable device and providing a signal to an activation controller 32 which is responsive to the free-fall detection sensor 30 and connected to the impact absorbing arms 22, whereby the arms are extended from their retracted position to their extended position upon detection of dangerous free-fall conditions to provide impact protection for the portable device. However, the prior art uses “extension means” to “force” the protection system and the “resilient arm” being pivoted or sliding out of mounting.

Hence, most of the available protective casing in the market, do not provide a light-weight case, without appreciably detracting from the compactness of the object and its transportability and which protects the object when inadvertently dropped while being manually carried. Moreover, there is no protective casing available that protects the entire fragile object from the effects of impact on dropping. Further, the existing protective casings are not provided with means to facilitate buffering of kinetic energy into a combination of elastic storage and energy dissipation and/absorption.

In view of the hitherto drawbacks of the existing protective casing, there exists a need to provide an improved system and device for protecting of fragile or delicate objects from the effect of impact during fall, irrespective of the orientation.

### OBJECT OF THE INVENTION

The main object of the present invention is to provide a system and device for protecting of fragile or delicate objects from the effects of impact due to accidental crash and drops.

It is another object of the present invention is to provide a system and device for improved protective casing of fragile objects from accidental crash and drops, irrespective of the orientation of fall.

It is yet another object of the present invention is to provide a system and device that does not compromise with the form of the device.

It is yet another object of the present invention is to provide method that keeps the protection mechanism locked in a strained configuration in the device and subsequently actuates it only on detection of fall.

It is yet another object of the present invention is to provide mechanism for elastic conversion of the kinetic energy gained during the fall of the object and/or to facilitate absorption and/or dissipation of the kinetic energy. This is to prevent deformation of the object upon the collision with an impact surface.

It is yet another object of the present invention is to provide a power management means such that the protective casing does not require any continuous power source.

It is still another object of the present invention is to provide a light-weight, cost effective and aesthetically pleasing protective case.

### SUMMARY OF THE INVENTION

The following presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

Accordingly, in one aspect, the present invention provides a system for protecting of fragile or delicate objects from impact forces during a fall, wherein said system comprising:
at least one detection system for continuously monitoring a state of said objects and configured to detect an event of fall of said objects;
at least one actuation mechanism responsive to said event of fall of said objects detected by said detection system;
at least one energy transfer mechanism triggered by said actuation mechanism, wherein said energy transfer mechanism adapted to be originally configured in a strained configuration and to subsequently trigger to expand to a free state configuration when an event of fall is detected;
wherein, said energy transfer mechanism adapted to first receive said impact force such that said energy transfer mechanism makes a contact with an impact surface before said object, and thereby said energy transfer mechanism adapted to enable partial buffering of kinetic energy on collision of said object with said impact surface, thereby protecting said objects falling with any orientation from said impact force.

In second aspect, the present invention provides a protection device for protection of said fragile or delicate objects from an impact force during a fall, wherein said device comprising:
a cover means removably attached with said fragile or delicate objects;
an actuation means provided within said cover means and adapted to respond to an event of fall of said objects detected by a free-fall detection means;
at least one energy transfer mechanism triggered by said actuation means, wherein said energy transfer mechanism adapted to be originally configured in a strained configuration and to subsequently trigger to expand to a free state configuration when an event of fall is detected;
wherein, said energy transfer mechanism adapted to first receive said impact force such that said energy transfer mechanism makes a contact with an impact surface before said object, and thereby said energy transfer mechanism adapted to enable partial buffering of kinetic energy on collision of said object with said impact surface, thereby protecting said objects falling with any orientation from said impact force.

In third aspect, the present invention provides a system for protecting of fragile or delicate objects from an impact force during a fall, wherein said system comprising:
at least one detection system for continuously monitoring a state of said objects and configured to detect an event of fall of said objects;
at least one actuation mechanism responsive to said event of fall of said objects detected by said detection system;
at least one protection system triggered by said actuation mechanism and adapted to buffer kinetic energy, wherein said protection system comprises:
   at least one energy transfer mechanism originally configured in a strained configuration and subsequently expanded into a free state configuration when said event of fall is detected, wherein, said energy transfer mechanism adapted to first receive said impact force such that energy transfer mechanism comes in contact with said impact surface before said object;
   at least one energy buffer mechanism coupled to said energy transfer mechanism and adapted to receive output from said energy transfer mechanism to facilitate partial kinetic energy buffering, thereby protecting said objects falling with any orientation from said impact force.

In fourth aspect, the present invention provides a protection device for protection of said fragile or delicate objects from an impact force during a fall, wherein said device comprising:
a cover mean removably arranged with fragile or delicate objects;
an actuation means provided within said cover means and adapted to respond to an event of fall of said objects detected by a free-fall detection means;
at least one protection system triggered by actuation of said actuation means and adapted to buffer kinetic energy gained during the fall of the object, wherein said protection system comprises:
   at least one energy transfer mechanism mounted on said cover means, and originally configured in a strained configuration and subsequently expanded into a free state configuration when said event of fall is detected, wherein, said energy transfer mechanism adapted to first receive said impact force such that energy transfer mechanism comes in contact with said impact surface before said object;
   at least one energy buffer mechanism coupled to said energy transfer mechanism and adapted to receive output from said energy transfer mechanism to facilitate partial kinetic energy buffering, thereby protecting said objects falling with any orientation from said impact force.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE ACCOMPANYING DRAWINGS

The above and other aspects, features, and advantages of certain exemplary embodiments of the present invention will be more apparent from the following description taken in conjunction with the accompanying drawings in which:

FIG. 1 illustrates block diagram of the system and device for protecting fragile objects, in accordance with an embodiment of the present subject matter.

FIG. 2 illustrates the complete circuit diagram of the system, in accordance with an embodiment of the present subject matter.

FIG. 3 illustrates the sequence of operations performed by the free-fall detection system, in accordance with an embodiment of the present subject matter.

FIG. 4 is an illustration of the actuated configuration of the protective case having energy transfer mechanism of curved beams with links, in accordance with the first embodiment of the present invention.

FIG. 5 is an illustration of the energy transfer mechanism of three revolute one prismatic (3R1P) protection mechanism, in accordance with second embodiment of the present invention.

FIG. 6 illustrates the locked configuration of the protective device with energy transfer mechanism of elastically strained curved beams at corners, in accordance with third embodiment of the present invention.

FIG. 7 illustrates the various views of the actuated configuration of the protective device with energy transfer mechanism comprising of elastically strained curved beams at corners, in accordance with third embodiment of the present invention.

FIG. 8 illustrates the energy transfer mechanism of rectangular bar with cam profile and follower means, in accordance with fourth embodiment of the present invention.

FIG. 9 illustrates the energy transfer mechanism of U-shaped links means running along the curved profile members provided on the corners of the object, in accordance with fifth embodiment of the present invention.

FIG. 10 illustrates the string and block mechanism of the protective device, in accordance with an embodiment of the present subject matter.

FIG. 11 illustrates the lazy tong amplification mechanism of the protective case, in accordance with an embodiment of the present invention.

FIG. 12 illustrates the pulley and string amplification mechanism of the protective case, in accordance with an embodiment of the present invention.

FIG. 13 illustrates frictional block energy dissipation mechanism of the protective case, in accordance with an embodiment of the present invention.

FIG. 14 illustrates the cantilever snap fit joint for locking of the elastic curved profile members at the corners of the protective case, in accordance with an embodiment of the present invention.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

### DETAILED DESCRIPTION OF THE PRESENT INVENTION

The following description with reference to the accompanying drawings is provided to assist in a comprehensive understanding of exemplary embodiments of the invention. It includes various specific details to assist in that understanding but these are to be regarded as merely exemplary.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Features that are described and/or illustrated with respect to one embodiment may be used in the same way or in a similar way in one or more other implementation and/or in combination with or instead of the features of the other implementation.

It should be emphasized that the term “comprises/comprising” when used in this specification is taken to specify the presence of stated features, integers, steps or components but does not preclude the presence or addition of one or more other features, integers, steps, components or groups thereof.

The present invention relates to a system and device for protection of fragile or delicate objects. Although the system may be discussed with respect to mobile electronic device, the devices and techniques disclosed herein are equally applicable to other types of fragile devices. Accordingly, the discussion of any embodiment is meant only to be exemplary and is not intended to suggest that the scope of the disclosure, including the claims, is limited to these examples.

Further, herein the term “energy transfer mechanism” can be alternatively be called as protection mechanism since it is adapted to prevent the direct impact of the force on the object.

There is provided a protection device for protection of fragile objects from impact due to the collision of the fragile objects with the impact surface. The protection device may be comprising of: a cover means for receiving a free-fall detection means for detecting an event of fall and/or means for receiving signals corresponding to the event of fall from the object; power management means; and actuation mechanism; and protection system to buffer the kinetic energy gained during the fall of the object. The device may be removable arranged with the delicate objects/phones in a form of a protective case.

In one embodiment, the power management means can eliminate the need of any continuous external power source for the detection means and actuation mechanism. The compact actuation mechanism can be adapted for triggering the protection system so that it can buffer kinetic energy on collision with a surface, thereby safeguarding the device falling with any orientation from the impact force.

In an exemplary embodiment, the protection system may be manually reloaded after fall for further use. The power means of the present invention may require charging after some cycles of actuation.

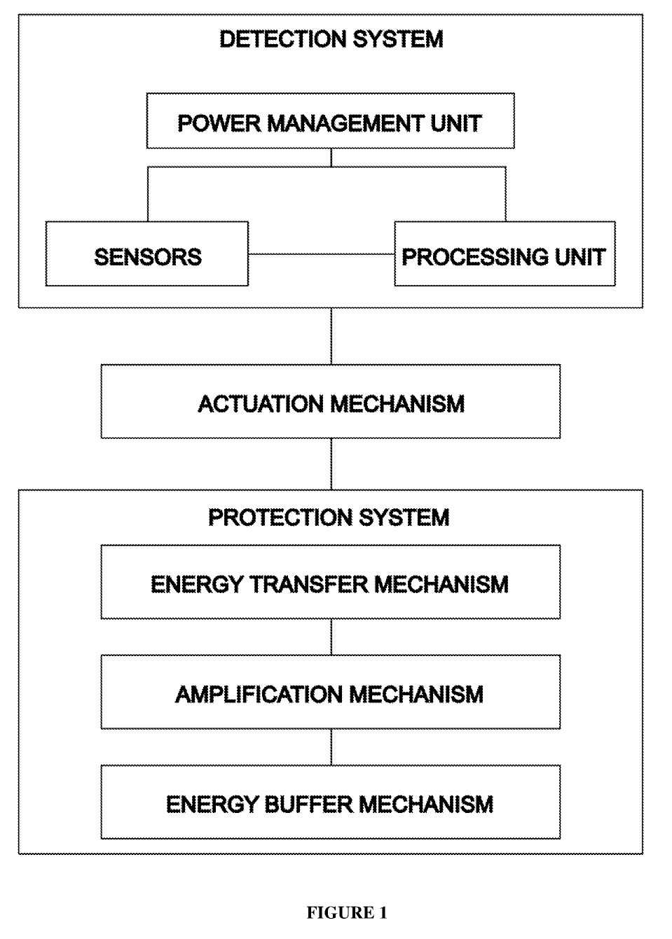

Referring to FIG. 1, the complete set of subsystems which can be a part of the system and device for protecting fragile objects are shown in the system components diagram. In one embodiment, the system may comprise of: a detection system; actuation mechanism; and protection system. The protection mechanism may further comprise of an energy transfer mechanism and/or amplification mechanism and/or and energy buffer mechanism. It may be possible that in one of the embodiments, all of these subsystems are not required hence are absent. For example in some cases amplification mechanism may not be required, only energy transfer mechanism directly coupled with energy buffer mechanism may provide required protection whereas in some cases all of the subsystems may be required to function coherently for providing complete impact protection.

In one embodiment, the energy buffer mechanism may be coupled to the energy transfer mechanism so as to receive output from the energy transfer mechanism and to facilitate said kinetic energy buffering. The amplification mechanism may be inserted between the energy transfer mechanism and said energy buffer mechanism for increasing said output from said energy transfer mechanism.

In one embodiment, the system may include a free-fall detection means adapted for detection of an event of fall. The said means continuously monitors the state of the object so as to trigger the protection system in the event of fall. The said means may be an accelerometer and the like that can be provided with internal or external processing unit. For continuous operation of accelerometer and actuation system the suitable power management means may be needed. This can be done using super-capacitors or battery which may be adapted to store the required amount of energy. They have to be re-charged after some cycles of actuation.

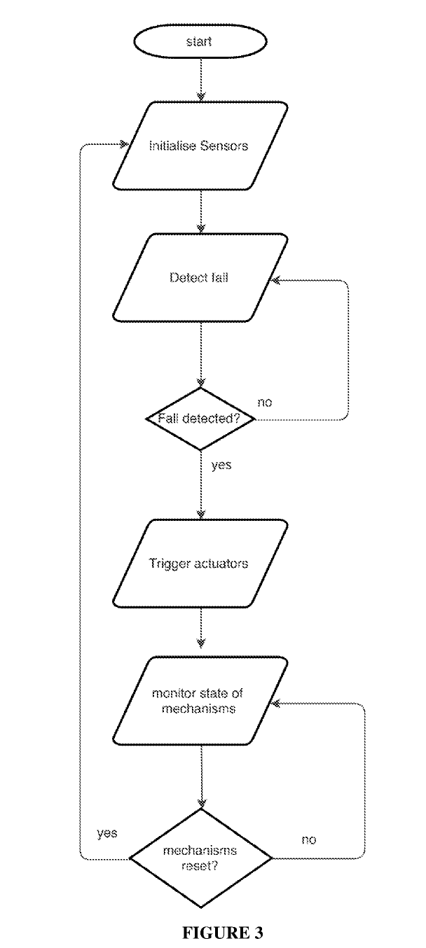

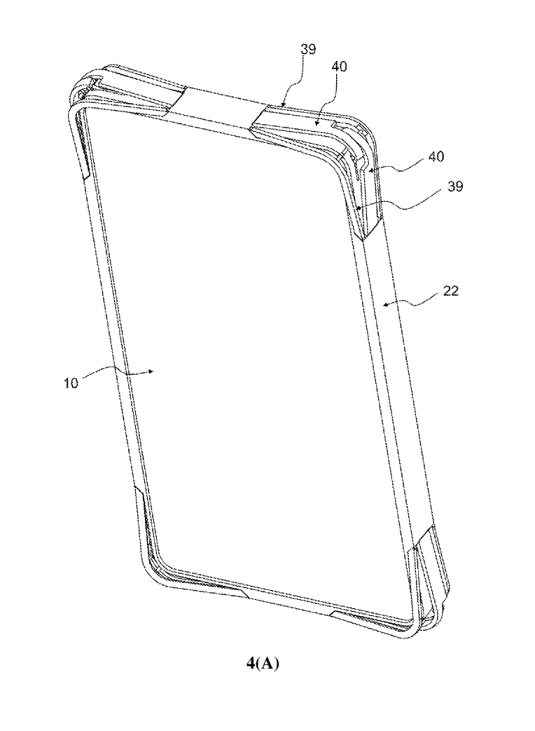

In a preferred embodiment, free-fall detection means for detection of fall can be a single component which incorporates both sensor and processing unit i.e. which can both sense and trigger the actuator that is to be used. Use of such unit will make the detection process completely independent of the object on which the case is used. The block diagram explaining the sequence of operations in the detection system is shown in FIG. 3.

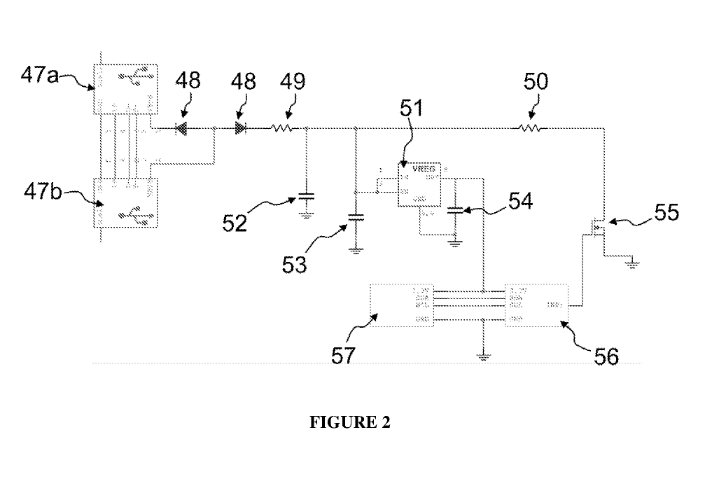

Referring to FIG. 2, provides one of the possible circuit diagram of the system according to an embodiment of the present invention. The components in the diagram along with their reference numerals are as follows:
47a—power connector 1
47b—power connector 2
48—diode
49—resistance 1
50—resistance 2
51—voltage regulator
52—capacitor 1
53—capacitor 2
54—capacitor 3
55—MosFET
56—Accelerometer
57—programming connector

In another preferred embodiment, if the object to be protected is any electronic device with in-built sensors and power source wherein the electronic device may be selected from a phone or tablet or laptop, then the freefall state of the electronic device can be detected using the sensors embedded in the electronic device. One of the sensors that may be found in almost all electronic devices which can be used for the purpose of detection is accelerometer. In this embodiment, the data from the sensors would have to be sent to the case from the device which can be achieved in any of the following ways that may include but not limited to, Bluetooth, near field communication (NFC), using headphone socket, USB, Wi-Fi or vibration of the device (for example recognizing specific wave patterns like change in frequency, duty cycle, amplitude and the like). Once the data from the sensor is received, system of the protective case needs to process it for triggering actuators which could be achieved by using a processing unit. This method eliminates the need of separate sensors and power source for the case as power can be extracted from the device.

In the various embodiments of the present invention, the energy transfer mechanism may comprise any of the following arrangements:
1. Elastically strained curved beams with link means;
2. Three revolute one prismatic (3R1P) mechanism;
3. Elastically strained curved beams
4. CAM profile with a follower means;
5. U shaped links at corner.

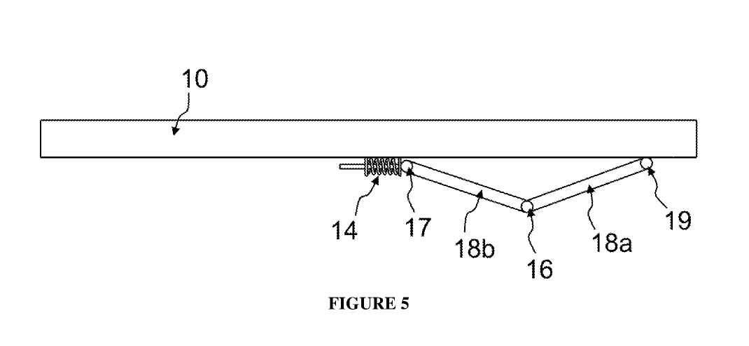

In second embodiment, referring to FIG. 5, illustrates the energy transfer mechanism having a 3R1P mechanism. In 3R1P mechanism, as the slider (17) having links (18a, 18b) moves, it compresses/elongates the spring means (14). Initially, the spring (14) may be in its compressed state and the revolute joint (16) (referred to as point B in the text) may be in contact with the object's surface. Now as soon as the fall is detected the mechanism attain a free state configuration (as shown in FIG. 5), slider (17) moves and the point B is moved such that it comes in contact with the ground before the object does. As point B (16) hits the ground it moves up which in turn pushes the slider (prismatic joint) which subsequently compresses/elongates the spring thereby converting the kinetic energy of the object into potential energy of the spring. The placement and number of such 3R1P mechanism is not limited to the configuration shown in FIG. 5 rather both the number and placement may vary in order to enhance protective characteristics. Rather than connecting the end point of the slider directly to spring, string may be attached to the end point of the slider, which may be further connected to amplification and/energy buffer mechanism described later.

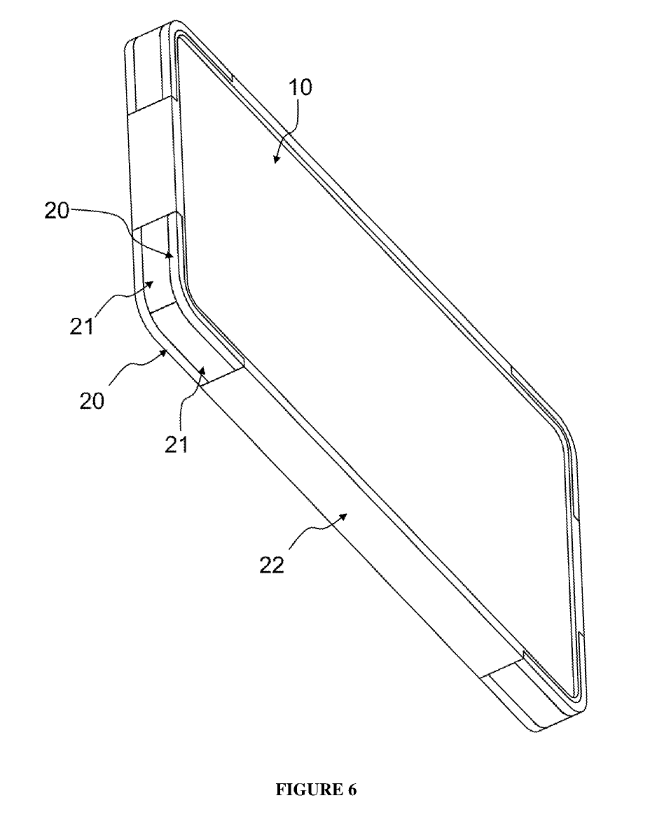

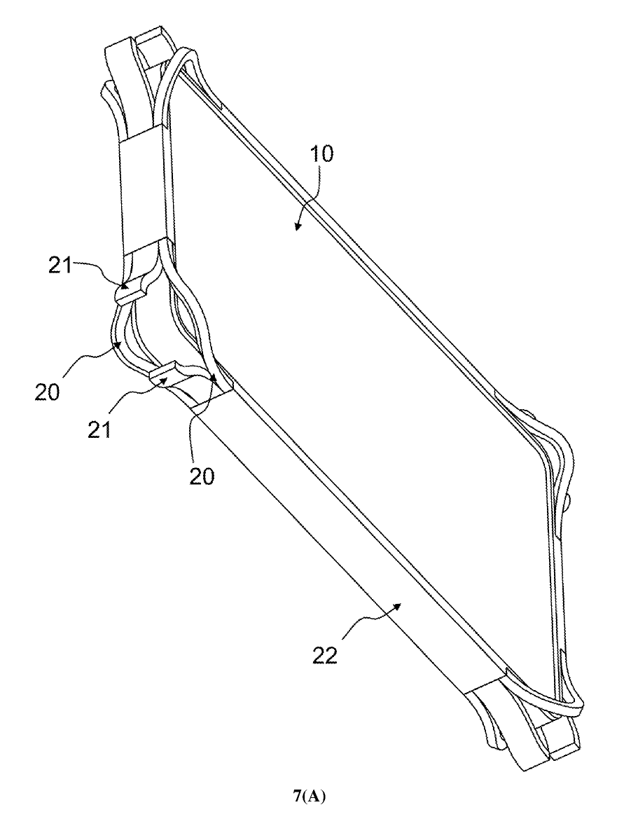

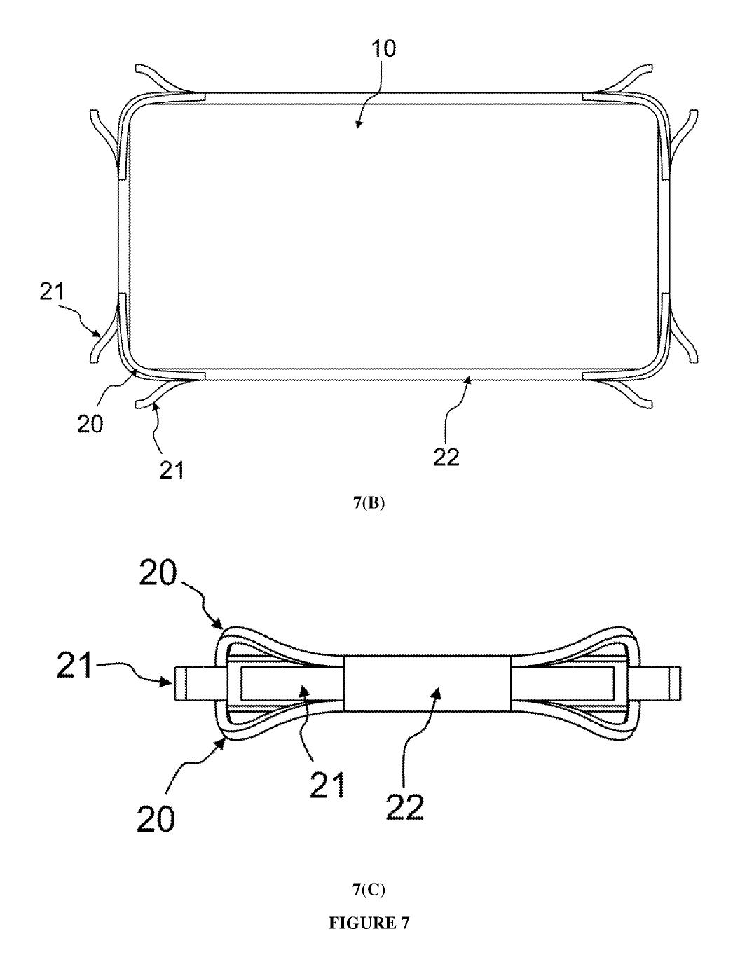

In third embodiment, referring to FIG. 6, which is an illustration of the locked/default configuration of the protective device, having elastically strained curved beams as an energy transfer mechanism. In the figure, the reference numeral (20) illustrates the front and back set of elastically strained curved beams and (21) illustrates the set of elastically strained curved beams for protecting side faces of the object. Herein, the curved beams (20, 21) may be fixed at four corners of the device, which undergo bending in case of impact with the ground. Initially, the curved beams may be locked in a strained state configuration where they are straight. As soon as locks are released by the actuation mechanism, the curved beams (20, 21) will get expanded into their free state as shown in the FIGS. 7A (isometric view), 7B (top view), 7C (front view) and thereby come in contact with the ground first, preventing the direct impact on object due to the fall. On impact with ground/impact surface, the impact forces on the curved beams leads to their elastic deformation. The present invention includes four curved beams at each corner as shown in the FIGS. 6 and 7, placed such that irrespective of the orientation with which the object is falling, it is safeguarded from impact. The placement and number of such curved beams is not limited to the configuration shown in FIGS. 6 & 7 rather both the number and placement may vary in order to enhance protective characteristics.

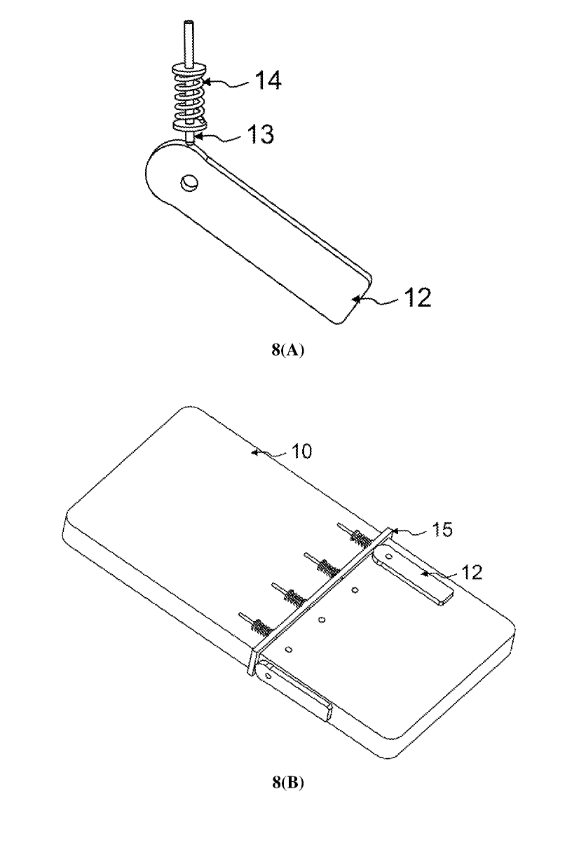

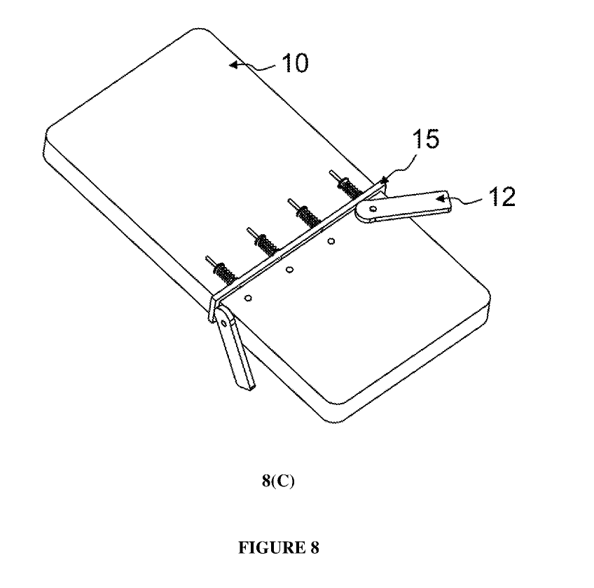

In fourth embodiment, referring to FIG. 8, which illustrates an energy transfer mechanism having a rectangular bar with CAM profile (12) and a follower means (13) coupled to a spring means (14) (FIG. 8A). In the embodiment, the default configuration is as shown in FIG. 8B, wherein the rectangular bars may be supported on face and side of the cover means whose one end may include cam profile with its follower (15) running all along the back and side of the object. In the actuated configuration, the CAM profile supports may hit the ground (as shown in FIG. 8C), such that the rectangular bars (12) may rotate about the revolute joint which gives a linear motion to the follower means (15) whose one end may compress the spring means (14) attached to it, such that the kinetic energy of the object may be converted into the spring's potential energy. The placement and number of such CAM profile (12) supports is not limited to the configuration shown in FIG. 8 rather both the number and placement may vary in order to enhance protective characteristics. Rather than connecting the end point of the follower directly to spring, string may be attached to the end point of the follower, which is further connected to amplification and/or energy buffer mechanism described later.

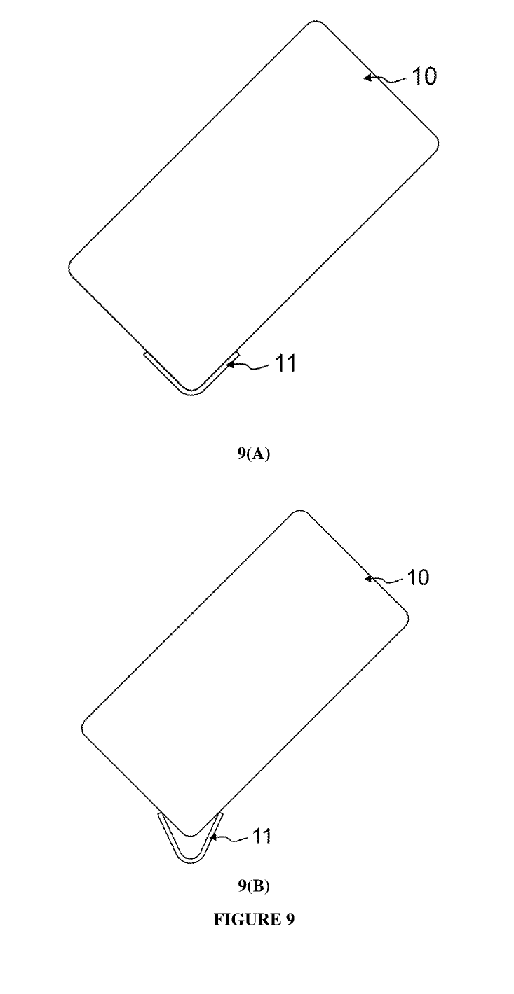

In fifth embodiment, referring to FIG. 9, which illustrates links means (11) at corner as the energy transfer mechanism. The link means may be running along the curved profile on the corners of the object. The links can be preferably selected as U shaped. In the present invention, initially the link means runs along the profile on the corner of the object. It may be locked in this strained configuration as shown in FIG. 9(A). As the lock is removed, the link means may pop out and gets locked into subsequent lock in which it is in its free state as shown in FIG. 9B. On impact the link means deforms elastically thereby storing the kinetic energy of the object in form of strain energy.

In all the embodiments, the energy dissipated/absorbed is proportional to the impact force acting on the energy transfer mechanism. So if forces turn out to be high owing to small displacement of the energy transfer mechanism, then amplification of this movement may be done to lower the forces.

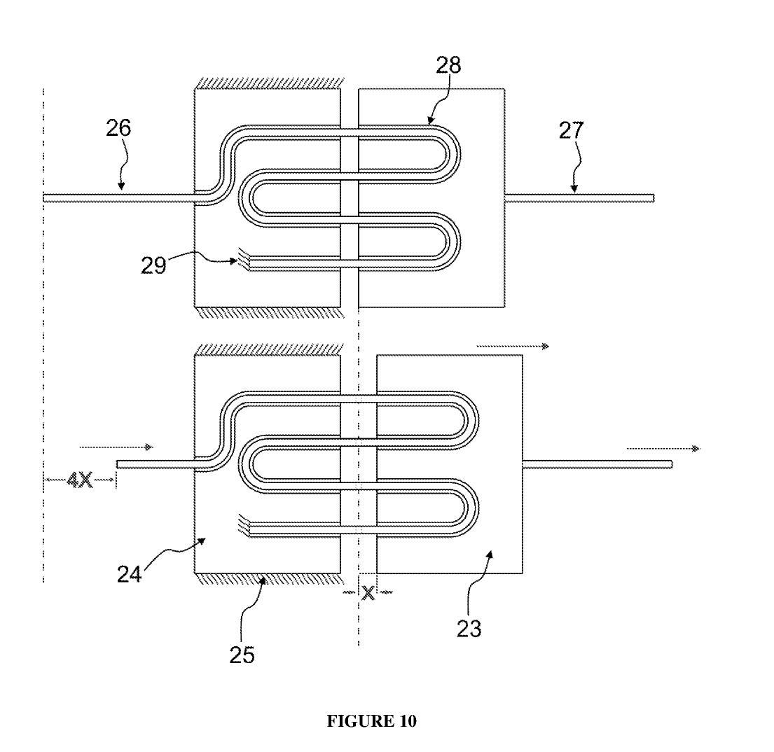

In an exemplary embodiment, an amplification mechanism may be optionally be used with the system for protection of fragile or delicate objects. A few mechanisms that may be used as preferable embodiment are described below:
1. String and block mechanism—Referring to FIG. 10, illustrates the string and block mechanism of the protective case, in accordance with an exemplary embodiment of the amplification mechanism. The figure shows String/Rope (26) whose end may be connected to an energy buffer mechanism described later; string/rope (26) whose one end (29) is fixed to block A (24) and other end is connected to the energy buffer mechanism; block A (24); Block B (23); and string/rope (27) whose one end is connected to block B (23) and other is connected to end points of energy transfer mechanism. In the FIG. 10, block ‘A’ may be fixed and one end of the string (26), running inside the grooves (28) in the blocks A and B, may be attached to the energy buffer mechanism whereas the other end of the string may be fixed to block A. Now on impact as block B is pulled by a distance x which may be equivalent to displacement of energy transfer mechanism, the n (in an exemplary implementation in FIG. 10, n may be equal to 4) parts of strings between block A and B also travel by x, so the resulting displacement of energy buffer mechanism is nx (in the FIG. 9, n is equal to 4, so resulting displacement will be 4x). So on impact, displacement of the energy transfer mechanism is amplified n times before being connected to energy buffer mechanism described later.
2. Lazy tong mechanism—Also known as scissor lift mechanism, the mechanism can be used in the implementation of the present invention so as to widely achieve amplification according to another exemplary embodiment of the amplification mechanism. Herein, reference can be made to FIG. 11, which illustrates revolute joint (30) to which string from energy transfer mechanism may be connected, a fixed point (31), revolute joint (32) to which string from energy transfer mechanism may be connected, revolute joint (33) which may be connected to the energy buffer mechanism, and links of the lazy tong mechanism (34). The string coming from the end points of energy transfer mechanisms described earlier can be connected to points 30 or 32 as shown in FIG. 11. The other end point 33 of the lazy tong mechanism may be connected to energy buffer mechanism described later. The amplification attained is directly proportional to the number of links (n−2)/2 (herein, n is selected as 10 in the given FIG. 11 for example) present between the end points.
3. Rack and pinion mechanism—The string coming from the energy transfer mechanisms described earlier can be connected to either the rack or the pinion according to another exemplary embodiment of the amplification mechanism.

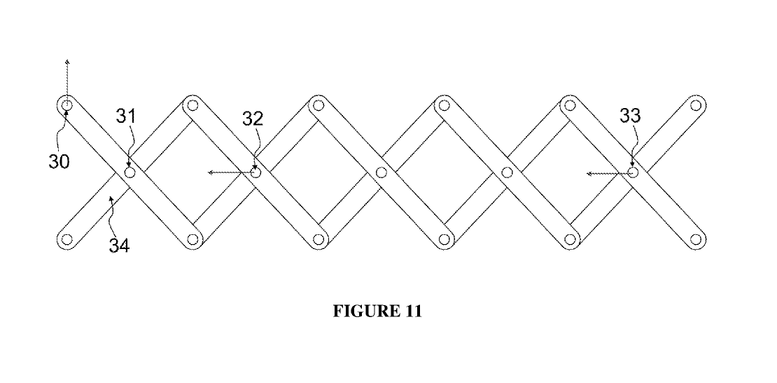

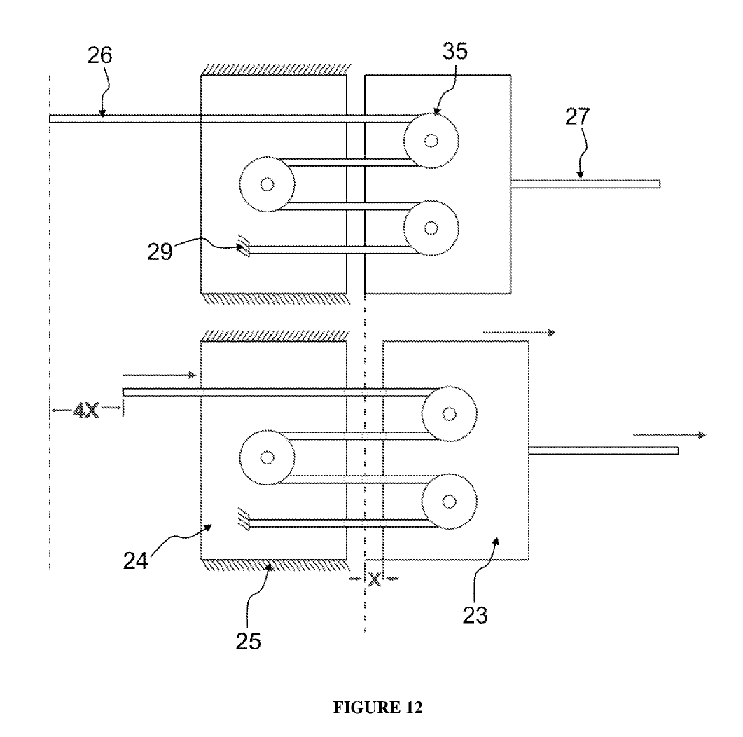

Herein, another string from either rack or pinion (whichever is not connected to energy transfer mechanism) may be coupled with energy buffer mechanism. The amplification achieved may be dependent on the gear ratio between rack and pinion.
4. Pulley and string mechanism—Herein, reference is made to FIG. 12 which illustrates the pulley and string amplification mechanism of the protective case according to another exemplary embodiment of the amplification mechanism. In this type of mechanism, single string runs along a number of pulleys out of which some are fixed and some are free to move linearly. One end of the string (27) may be connected to the energy transfer mechanism described earlier and the other end may be connected to energy buffer mechanism. Pulleys (35) may be fixed to block (23) and (24) out of which block (24) is to be fixed whereas block (23) moves linearly with its movement linked to the displacement of the energy transfer mechanism to which it is connected. Now as block B travels by distance x, the n+1 (n is the number of pulleys through which the string passes) parts of strings between block (23) and (24) also travel by x, so the resulting displacement of the end connected to energy buffer mechanism may be (n+1)*x. The amplification factor (n+1) depends on the number of pulleys (n is 3 in FIG. 12) through which the string passes.
5. Gear train mechanism—In this exemplary embodiment, a number of gears, with parallel axis, are mounted on a frame so that gears engage in pairs to attain a certain gear ratio. The string coming from the end points of energy transfer mechanisms described earlier can be connected to one of the gear. Once the desired amplification is attained (which depends on the gear ratio between each pair of gears) a string from the last gear can be connected to the energy buffer mechanism described later.

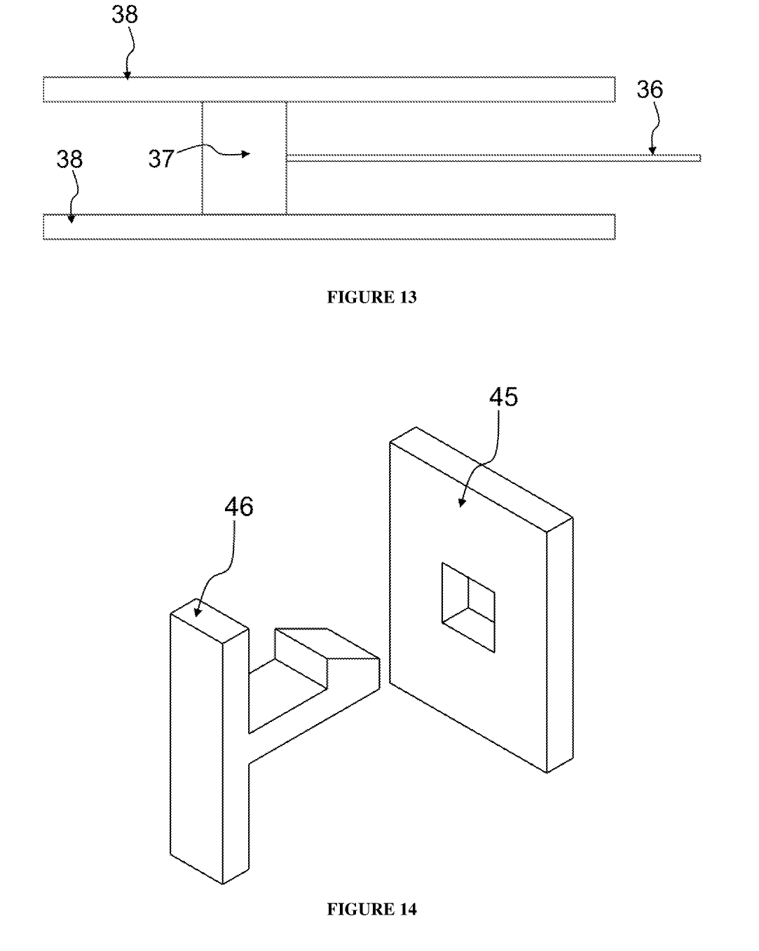

In one embodiment, the output from the amplification mechanisms described above may be further connected to an energy buffer mechanism. An exemplary embodiment of the energy buffer mechanism is illustrated in FIG. 13. The various energy buffer mechanism that may be used in the present invention are described below−
1. Spring mechanism—In this exemplary embodiment, amplified displacement of the end points of energy transfer mechanism may be coupled with springs so a part of the kinetic energy of the object gets stored in the potential energy of the springs.
2. Collapsible structures on faces of the object—In this exemplary embodiment, amplified output displacement from amplification mechanisms may be converted into the plastic deformation of collapsible structures. In this way the kinetic energy of object is dissipated in the form of plastic deformation. In this mechanism collapsible structures which undergo plastic deformation may have to be replaced after one use with another set of structures.
3. Buckling structures—In this exemplary embodiment, the output of the amplification mechanism in the form of pulling of string could be coupled with beams which would buckle under the force applied by strings when protection mechanism hits the surface. So in this way kinetic energy of the object would be converted into elastic energy of buckled beams. Beams could be selected from I-beams or square beams or H-beams and the like.
4. One way dampers—In this exemplary embodiment, amplified output displacement from amplification mechanism would be coupled with one way dampers. So when the string would be pulled, it would face resistance from the dampers (resistance proportional to the velocity of pulling) thereby dissipating the kinetic energy of object in form of heat energy.
5. Elastic extension—In this exemplary embodiment, amplified output displacement from amplification mechanism would be coupled with elastically deformable materials like rubber, steel etc. thereby converting the kinetic energy of the object into elastic deformation i.e. elastic energy.
6. Frictional block mechanism—In this exemplary embodiment, amplified output displacement from amplification mechanism is coupled with the linear movement of a block which experiences frictional resistance due to the walls along which it slides. The mechanism is illustrated in FIG. 13. In the figure, Block (37) linearly slides linearly along the walls, and string (36) whose one end is connected to block (37) and other end is connected to energy transfer mechanism or amplification mechanism. The wall (38) offers frictional resistance to the movement of the block (37). So, kinetic energy of object may be dissipated in the form of heat generated due to frictional forces

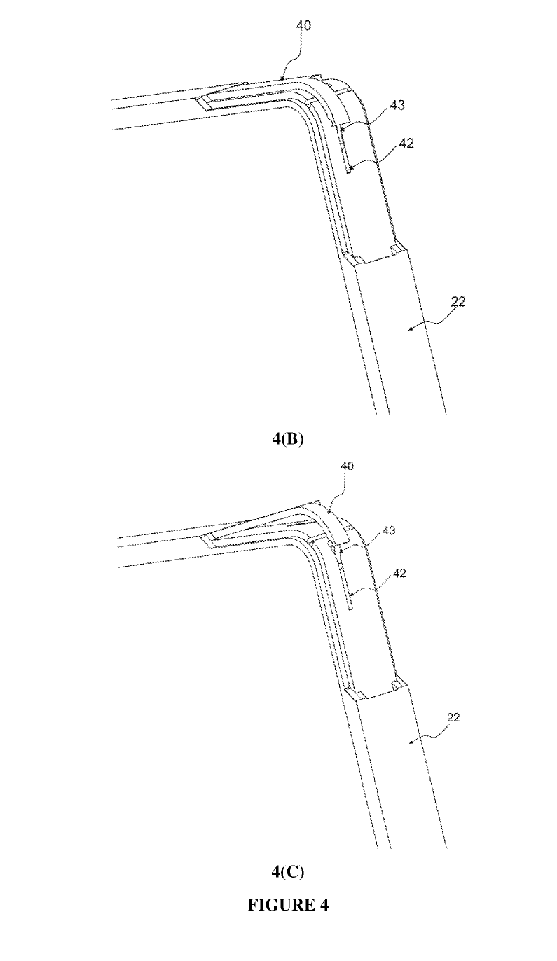

In one exemplary embodiment, the frictional block mechanism coupled with elastically strained curved beams with links is explained. Referring to FIGS. 4 and 13, the curved beams (40) may be fixed at one end with other end being free to displace in the actuated configuration, so they behave as cantilever beam. The elastically strained beams (40) are connected with links (43) whose other end runs along the pathways (42). The movement of the end of the link (43) in the pathways (42) may be coupled with the displacement of the frictional block (as shown in FIG. 13) on the faces either directly or with the help of strings. Frictional forces opposing the motion of block along the walls dissipate the kinetic energy of the object. The displacement of the end of the link (43) may be amplified before being converted into the linear movement of the block with the help of amplification mechanism as explained above.

In all the embodiments, there is provided an actuation mechanism for locking of the energy transfer mechanism in the strained configuration. These locks may be subsequently released once the event of fall is detected. So for keeping the energy transfer mechanism locked in its strained configuration, the present invention may use cantilever snap fit joints (as shown in FIG. 14) and the like, which in the event of fall can be released by actuation mechanism. In the FIG. 14, (46) illustrates cantilever arm with protruding part that engages into corresponding depression and (45) illustrates the fixed support containing the depression (undercut).

In one embodiment, the actuation mechanism selectively comprises shape memory alloy wires or solenoid or electro-active polymer or piezo-electric material or any combination thereof as electromechanical actuators. For releasing the locks of the energy transfer mechanism in the event of fall shape memory alloy (electromechanical actuators) wires are used which may be attached to cantilever arm of the snap fit joint.

Once the fall is detected, current is passed into these wires which heats them up leading to contraction in the length of these wires thereby providing necessary actuation of the snap fit joint.

Some of the non-limiting advantages of the present invention are as follows:
The improved protective casing protects the fragile objects from accidental crash and drops, irrespective of the orientation of fall.
The protective case is provided with a power management means such that the system do not require any external power source, making it independent of the said fragile object.
The system is a light-weight, cost effective and aesthetically pleasing protective case.
The system has lesser number of components as compared to the existing protection cases and therefore it is economically significant.

Although a system and device for protecting fragile objects have been described in language specific to structural features and/or methods, it is to be understood that the embodiments disclosed in the above section are not necessarily limited to the specific features or methods or devices described. Rather, the specific features are disclosed as examples of implementations of the system and device for protecting fragile objects.

1. A system for protecting of fragile or delicate objects from impact forces during a fall, wherein said system comprising:
at least one detection system for continuously monitoring a state of said objects and configured to detect an event of fall of said objects;
at least one actuation mechanism responsive to said event of fall of said objects detected by said detection system;
at least one energy transfer mechanism triggered by said actuation mechanism, wherein said energy transfer mechanism adapted to be originally configured in a strained configuration and to subsequently trigger to expand to a free state configuration when an event of fall is detected;
wherein, said energy transfer mechanism adapted to first receive said impact force such that said energy transfer mechanism makes a contact with an impact surface before said object, and thereby said energy transfer mechanism adapted to enable partial buffering of kinetic energy on collision of said object with said impact surface, thereby protecting said objects falling with any orientation from said impact force.

2. The system as claimed in claim 1, wherein said energy transfer mechanism is at least one elastically strained curved profile members connected to one or more link means running along a pathway or at least one 3 revolute one prismatic (3R1P) mechanism having a slider with a prismatic joint or at least one elastically strained curved profile members provided on corners of said objects or an assembly of at least one bar means having cam profile; and a follower means, wherein said bar means directly or indirectly coupled to said follower means or one or more U-shaped links running along one or more profiles on corners of said object.

3. (canceled)

4. (canceled)

5. (canceled)

6. (canceled)

7. (canceled)

8. (canceled)

9. (canceled)

10. (canceled)

11. The system as claimed in claim 1, wherein said actuation mechanism selectively comprises shape memory alloy wires or solenoid or electro-active polymer or piezo-electric material or any combination thereof as electromechanical actuators.

12. A protection device for protection of said fragile or delicate objects from an impact force during a fall, wherein said device comprising:
a cover means removably attached with said fragile or delicate objects;
an actuation means provided within said cover means and adapted to respond to an event of fall of said objects detected by a free-fall detection means;
at least one energy transfer mechanism triggered by said actuation means, wherein said energy transfer mechanism adapted to be originally configured in a strained configuration and to subsequently trigger to expand to a free state configuration when an event of fall is detected;
wherein, said energy transfer mechanism adapted to first receive said impact force such that said energy transfer mechanism makes a contact with an impact surface before said object, and thereby said energy transfer mechanism adapted to enable partial buffering of kinetic energy on collision of said object with said impact surface, thereby protecting said objects falling with any orientation from said impact force.

13. The device as claimed in claim 12, wherein said free-fall detection means provided within said cover means for continuously monitoring a state of said objects and configured to detect an event of fall of said objects so as to trigger said actuation means.

14. The device as claimed in claim 12, wherein said cover means communicably coupled to one or more detection sensors adapted within said objects to receive signals corresponding to an event of fall detected by said detection sensors.

15. The device as claimed in claim 12, wherein said free-fall detection means comprises sensors and/or one or more accelerometer with internal or external processing unit adapted to detect the free fall of said objects to subsequently trigger said actuation means.

16. The device as claimed in claim 15, further comprises a power management means to provide continuous supply to said accelerometer and actuation means.

17. The device as claimed in claim 12, wherein said energy transfer mechanism is at least one elastically strained curved profile members mounted on corners of said cover means and said curved profile members connected to one or more link means running along a pathway or at least one 3 revolute one prismatic (3R1P) mechanism mounted on said cover means and having a slider with a prismatic joint or at least one elastically strained curved profile members provided on corners of said objects or an assembly of at least one bar means having cam profile; and a follower means, wherein said bar means directly or indirectly coupled to said follower means or one or more U-shaped links running along one or more profiles on corners of said object.

18. (canceled)

19. (canceled)

20. (canceled)

21. (canceled)

22. (canceled)

23. (canceled)

24. (canceled)

25. (canceled)

26. The device as claimed in claim 12, wherein said energy transfer mechanism is originally locked in said strained configuration by means of a cantilever snap fit joints and the like.

27. A system for protecting of fragile or delicate objects from an impact force during a fall, wherein said system comprising:
at least one detection system for continuously monitoring a state of said objects and configured to detect an event of fall of said objects;
at least one actuation mechanism responsive to said event of fall of said objects detected by said detection system;
at least one protection system triggered by said actuation mechanism and adapted to buffer kinetic energy, wherein said protection system comprises:
at least one energy transfer mechanism originally configured in a strained configuration and subsequently expanded into a free state configuration when said event of fall is detected, wherein, said energy transfer mechanism adapted to first receive said impact force such that energy transfer mechanism comes in contact with said impact surface before said object;
at least one energy buffer mechanism coupled to said energy transfer mechanism and adapted to receive output from said energy transfer mechanism to facilitate partial said kinetic energy buffering, thereby protecting said objects falling with any orientation from said impact force.

28. The system as claimed in claim 27, wherein said energy transfer mechanism is at least one elastically strained curved profile members connected to one or more link means running along a pathway or an assembly of at least one bar means having cam profile; and a follower means, wherein said bar means directly or indirectly coupled to said follower means or at least one 3 revolute one prismatic (3R1P) mechanism having a slider with a prismatic joint or at least one elastically strained curved profile members provided on corners of said objects or one or more U-shaped links running along one or more profiles provided on corners of said object.

29. (canceled)

30. (canceled)

31. (canceled)

32. (canceled)

33. The system as claimed in claim 27, wherein said energy buffer mechanism is selectively a spring mechanism or collapsible structures on faces of said object or Buckling structures or one way dampers or elastic extension or frictional block mechanism.

34. The system as claimed in claim 33, optionally comprises: at least one amplification mechanism inserted between said energy transfer mechanism and said energy buffer mechanism for increasing said output from said energy transfer mechanism.

35. The system as claimed in claim 34, wherein amplification mechanism is selectively a string and block mechanism or Lazy tong mechanism or Rack and pinion mechanism or Pulley and string mechanism or Gear train mechanism.

36. A protection device for protection of said fragile or delicate objects from an impact force during a fall, wherein said device comprising:
a cover mean removably arranged with fragile or delicate objects;
an actuation means provided within said cover means and adapted to respond to an event of fall of said objects detected by a free-fall detection means;
at least one protection system triggered by actuation of said actuation means and adapted to buffer kinetic energy gained during the fall of the object, wherein said protection system comprises:
at least one energy transfer mechanism mounted on said cover means, and originally configured in a strained configuration and subsequently expanded into a free state configuration when said event of fall is detected, wherein, said energy transfer mechanism adapted to first receive said impact force such that energy transfer mechanism comes in contact with said impact surface before said object;
at least one energy buffer mechanism coupled to said energy transfer mechanism and adapted to receive output from said energy transfer mechanism to facilitate partial kinetic energy buffering, thereby protecting said objects falling with any orientation from said impact force.

37. The device as claimed in claim 36, wherein said energy transfer mechanism is at least one elastically strained curved profile members connected to one or more link means running along a pathway or at least one 3 revolute one prismatic (3R1P) mechanism mounted on said cover means and having a slider with a prismatic joint or at least one elastically strained curved profile members mounted on corners of said cover means or an assembly of at least one bar means having at least one cam profile; and a follower means, wherein said bar means directly or indirectly coupled to said follower means or one or more U-shaped links running along one or more profiles provided on corners of said object.

38. (canceled)

39. (canceled)

40. (canceled)

41. (canceled)

42. The device as claimed in claim 36 optionally comprises: at least one amplification mechanism inserted between said energy transfer mechanism and said energy buffer mechanism for increasing said output from said energy transfer mechanism

43. The device as claimed in claim 42, wherein said amplification mechanism is selectively a string and block mechanism or Lazy tong mechanism or Rack and pinion mechanism or Pulley and string mechanism or Gear train mechanism.

44. The device as claimed in claim 42, wherein said energy buffer mechanism is selectively a spring mechanism or collapsible structures on faces of said object or Buckling structures or one way dampers or elastic extension or frictional block mechanism.
